(19) United States
(12) Patent Application Publication
(10) Pub. No.: US 2006/0251015 A1
(43) Pub. Date: Nov. 9, 2006

(54) System and method for dynamic allocation of ARQ feedback in a multi-carrier wireless network

(75) Inventor: Farooq Khan, Allen, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 11/390,056

(22) Filed: Mar. 27, 2006

Related U.S. Application Data
(60) Provisional application No. 60/678,595, filed on May 6, 2005.

(51) Int. Cl. H04Q 7/00

(52) U.S. Cl. 370/329

(57) ABSTRACT

A base station for use in an OFDM wireless network. The base station transmits to a first subscriber station a first control message indicating a first uplink channel to be used by the first subscriber station for transmitting a first ACK/NACK message to the base station. The base station also transmits a first data traffic message associated with the first control message. The first ACK/NACK message transmitted to the base station indicates whether the first data traffic message was correctly received. The base station may transmit to the first subscriber station a subsequent control message indicating a second uplink channel to be used by the first subscriber station for transmitting a second ACK/NACK message back to the base station. The second uplink channel may be different that the first uplink channel.

### CROSS-REFERENCE TO RELATED APPLICATION AND CLAIM OF PRIORITY

The present application is related to U.S. Provisional Patent No. 60/678,595, filed May 6, 2005, entitled “ARQ Feedback Resource Indication In A Wireless Communication System”. U.S. Provisional Patent No. 60/678,595 is assigned to the assignee of this application and is incorporated by reference as if fully set forth herein. The present application hereby claims priority under 35 U.S.C. §119(e) to U.S. Provisional Patent No. 60/678,595.

### TECHNICAL FIELD OF THE INVENTION

The present application relates generally to wireless communications and, more specifically, to a mechanism for allocating acknowledgment request (ARQ) feedback messages in an orthogonal frequency division multiplexing (OFDM) network or an orthogonal frequency division multiple access (OFDMA) network.

### BACKGROUND OF THE INVENTION

Orthogonal frequency division multiplexing (OFDM) is a multi-carrier transmission technique in which a user transmits on many orthogonal frequencies (or subcarriers). The orthogonal subcarriers are individually modulated and separated in frequency such that they do not interfere with one another. This provides high spectral efficiency and resistance to multipath effects. An orthogonal frequency division multiple access (OFDMA) system allows some subcarriers to be assigned to different users, rather than to a single user. Today, OFDM and OFDMA technology are used in both wireline transmission systems, such as asymmetric digital subscriber line (ADSL), and wireless transmission systems, such as IEEE-802.11a/g (i.e., WiFi), IEEE-802.16 (e.g., WiMAX), digital audio broadcast (DAB), and digital video broadcast (DVB). This technology is also used for wireless digital audio and video broadcasting.

In conventional OFDM networks, a dedicated resource is allocated to each subscriber station (e.g., mobile device, wireless terminal, etc.) for ARQ feedback or hybrid ARQ feedback, such as an Acknowledgment (ACK) message or a Negative Acknowledgment (NACK) message. By way of example, a transmitter (e.g., base station) in a conventional OFDM wireless network sends the data packets along with the control information to a receiver (e.g., subscriber station). The control channel carries information specifying, for example, the sequence number and the modulation and coding scheme Used to encode the data packet. The subscriber station attempts to decode the data packet and transmits to the base station a feedback message regarding either a successful or an unsuccessful transmission in the dedicated ACK/NACK channel.

In the case of a NACK feedback message, the base station may retransmit the data packet and the process continues until the Packet is successfully received or a maximum number of retransmission attempts is reached. When the packet is Successfully received, the base station moves to the next packet in the transmission queue. Different types of retransmission Protocols may be used for reliable transmission in a wireless communication system. These retransmission protocols include stop-and-wait ARQ, selective repeat ARQ, and Go-back-N ARQ.

In the case of hybrid ARQ, the data packet to be transmitted is first encoded and the encoded data is divided into a number of subpackets. The base station sends the first subpacket, Subpacket 1, from Packet A and waits back for an ACK/NACK feedback message from the subscriber station. A NACK message indicates an unsuccessful transmission occurred. In response to a NACK message, the base station sends the second subpacket, Subpacket 2, from Packet A. The subscriber station combines the previously stored Subpacket 1 with the newly received Subpacket 2 and tries to decode Packet A. When a packet is successfully decoded, the base station moves to the transmission for a new packet.

Unlike simple ARQ, in hybrid ARQ, the previously received information is combined with the new information in order to decode a packet. In simple ARQ, if an unsuccessful transmission occurs, the erroneously decoded packet is discarded by the subscriber station and retransmitted by the base station.

However, in packet-oriented transmission environments, typically only a few subscriber stations are scheduled for transmission at any given time. Thus, the network needs to receive feedback information only from a few subscriber stations. As a result, the ACK/NACK schemes used in conventional wireless networks waste resources that are dedicated to ACK/NACK messages from subscriber stations that are not sending feedback.

Therefore, there is a need for improved OFDM or OFDMA transmission systems that minimize the resources dedicated to handling feedback messages from subscriber stations. In particular, there is a need for an improved OFDM or OFDMA transmission system that does not dedicate resources to handling feedback messages from subscriber stations that are not receiving data packets from the wireless network.

### SUMMARY OF THE INVENTION

A base station is provided for use in an orthogonal frequency division multiplexing (OFDM) network capable of communicating with a plurality of subscriber stations in a coverage area of the OFDM network. The base station is capable of transmitting to a first subscriber station a first control message indicating to the first subscriber station a first uplink channel to be used by the first subscriber station for transmitting a first ACK/NACK message back to the base station. The exemplary base station is further capable of transmitting to the first subscriber station a first data traffic message associated with the first control message, wherein the first ACK/NACK message transmitted back to the base station indicates whether the first data traffic message was correctly received.

The base station is further capable of transmitting to the first subscriber station a subsequent control message indicating to the first subscriber station a second uplink channel to be used by the first subscriber station for transmitting a second ACK/NACK message back to the base station. The second uplink channel is different that the first uplink channel.

In another embodiment, a method is provide for use in an orthogonal frequency division multiplexing (OFDM) network capable of communicating with a plurality of subscriber stations in a coverage area of the OFDM network. The method allocates uplink channel resources to selected ones of the subscriber stations. The method comprises the steps of: 1) transmitting to a first subscriber station a first data traffic message; and 2) transmitting to the first subscriber station a first control message associated with the first data traffic message, wherein the first control message indicates to the first subscriber station a first uplink channel to be used by the first subscriber station for transmitting a first ACK/NACK message back to the base station.

The method further comprises the steps of: 3) transmitting to a second subscriber station a second data traffic message; and 4) transmitting to the second subscriber station a second control message associated with the second data traffic message, wherein the second control message indicates to the second subscriber station a second uplink channel to be used by the second subscriber station for transmitting a second ACK/NACK message back to the base station. The first ACK/NACK message transmitted back to the base station indicates whether the first data traffic message was correctly received. The second ACK/NACK message transmitted back to the base station indicates whether the second data traffic message was correctly received.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network that handles ARQ and hybrid ARQ feedback messages according to the principles of the present disclosure;

FIG. 2A is a high-level diagram of an OFDMA transmitter according to one embodiment of the present disclosure;

FIG. 2B is a high-level diagram of an OFDMA receiver according to one embodiment of the present disclosure;

FIG. 3 is a message flow diagram illustrating the allocation of uplink channel resources according to the principles of the present disclosure;

FIG. 4 is a logic flow diagram illustrating the allocation of uplink channel resources in a subscriber station;

FIG. 5 illustrates an exemplary time-frequency grid for transmitting in logical uplink channels according to one embodiment of the present disclosure; and

FIG. 6 is a message flow diagram illustrating ACK/NACK feedback from multiple subscriber stations according to the principles of the present disclosure.

### DETAILED DESCRIPTION OF THE INVENTION

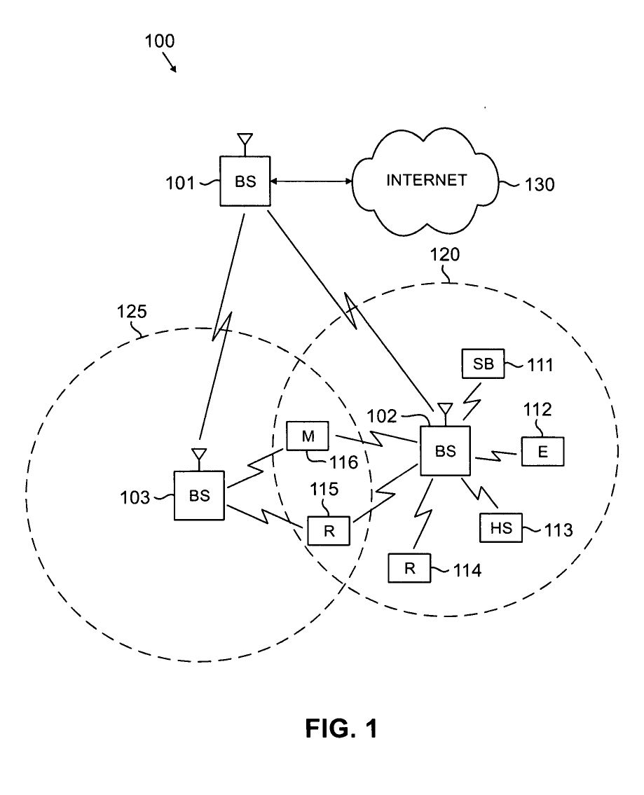

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

A transmission technique is disclosed in which the resource (e.g., communication channel) allocated for an ACK message or a NACK message is dynamically identified (or indicated) in a control channel message accompanying the data packet or data subpacket transmission from the transmitting device (e.g., a base station). The receiving device (e.g., a subscriber station) informs the transmitting device about the successful or unsuccessful transmission of the packet by sending an ACK message or a NACK message, respectively. The ACK/NACK is sent using the resource identified in the control channel message sent by the transmitting device. According to the principles of the present disclosure, the number of ACK/NACK resources needed is determined by the number of subscriber stations simultaneously scheduled for transmission and not by the total number of subscriber stations in the wireless network. The transmitting device may dynamically change the resource allocated to a subscriber station for ACK/NACK feedback on a transmission-by-transmission basis.

FIG. 1 illustrates exemplary wireless network 100, which handles ARQ and hybrid ARQ feedback messages according to the principles of the present disclosure. In the illustrated embodiment, wireless network 100 includes base station (BS) 101, base station (BS) 102, base station (BS) 103, and other similar base stations (not shown). Base station 101 is in communication with base station 102 and base station 103. Base station 101 is also in communication with Internet 130 or a similar IP-based network (not shown).

Base station 102 provides wireless broadband access (via base station 101) to Internet 130 to a first plurality of subscriber stations within coverage area 120 of base station 102. The first plurality of subscriber stations includes subscriber station 111, which may be located in a small business (SB), subscriber station 112, which may be located in an enterprise (E), subscriber station 113, which may be located in a WiFi hotspot (HS), subscriber station 114, which may be located in a first residence (R), subscriber station 115, which may be located in a second residence (R), and subscriber station 116, which may be a mobile device (M), such as a cell phone, a wireless laptop, a wireless PDA, or the like.

Base station 103 provides wireless broadband access (via base station 101) to Internet 130 to a second plurality of subscriber stations within coverage area 125 of base station 103. The second plurality of subscriber stations includes subscriber station 115 and subscriber station 116. In an exemplary embodiment, base stations 101-103 may communicate with each other and with subscriber stations 111-116 using OFDM or OFDMA techniques.

Base station 101 may be in communication with either a greater number or a lesser number of base stations. Furthermore, while only six subscriber stations are depicted in FIG. 1, it is understood that wireless network 100 may provide wireless broadband access to additional subscriber stations. It is noted that subscriber station 115 and subscriber station 116 are located on the edges of both coverage area 120 and coverage area 125. Subscriber station 115 and subscriber station 116 each communicate with both base station 102 and base station 103 and may be said to be operating in handoff mode, as known to those of skill in the art.

Subscriber stations 111-116 may access voice, data, video, video conferencing, and/or other broadband services via Internet 130. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer (PC), a laptop computer, a gateway, or another device.

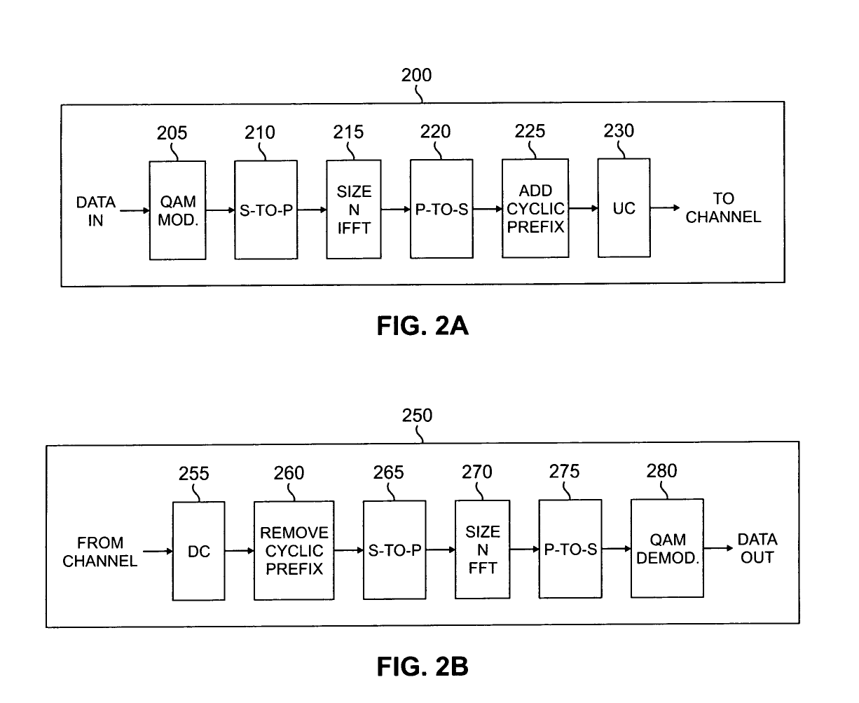

FIG. 2A is a high-level diagram of orthogonal frequency division multiple access (OFDMA) transmitter 200 according to one embodiment of the disclosure. FIG. 2B is a high-level diagram of orthogonal frequency division multiple access (OFDMA) receiver 250 according to one embodiment of the disclosure. OFDMA transmitter 200 comprises quadrature amplitude modulation (QAM) modulator 205, serial-to-parallel (S-to-P) block 210, Size N Inverse Fast Fourier Transform (IFFT) block 215, parallel-to-serial (P-to-S) block 220, add cyclic prefix block 225, and up-converter (UC) 230. OFDMA receiver 250 comprises down-converter (DC) 255, remove cyclic prefix block 260, serial-to-parallel (S-to-P) block 265, Size N Fast Fourier Transform (FFT) block 270, parallel-to-serial (P-to-S) block 275, and quadrature amplitude modulation (QAM) demodulator 280.

At least some of the components in FIGS. 2A and 2B may be implemented in software while other components may be implemented by configurable hardware or a mixture of software and configurable hardware. In particular, it is noted that the FFT blocks and the IFFT blocks described in this disclosure document may be implemented as configurable software algorithms, where the values of Size M and Size N may be modified according to the implementation.

In OFDMA transmitter 200, QAM modulator 205 receives a set of information bits and modulates the input bits to produce a sequence of frequency-domain modulation symbols. Serial-to-parallel block 210 converts (i.e., de-multiplexes) the serial QAM symbols to parallel data to produce N parallel symbol streams where N is the IFFT/FFT size used in transmitter 200 and receiver 250. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal.

Finally, up-converter 230 modulates (i.e., up-converts) the output of add cyclic prefix block 225 to RF frequency for transmission via a wireless channel. The signal may also be filtered at baseband before conversion to RF frequency. The time-domain signal transmitted by OFDMA transmitter 200 comprises multiple overlapping sinusoidal signals corresponding to the data symbols transmitted.

The transmitted RF signal arrives at OFDMA receiver 250 after passing through the wireless channel and reverse operations to those at OFDMA transmitter 200 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of QAM data symbols. QAM demodulator 280 then demodulates the QAM symbols to recover the original input data stream.

Each of base stations 101-103 may implement a transmit path that is analogous to transmitter 200 for transmitting in the downlink to subscriber stations 111-116 and may implement a receive path that is analogous to receiver 250 for receiving in the uplink from subscriber stations 111-116. Similarly, each one of subscriber stations 111-116 may implement a transmit path corresponding to the architecture of transmitter 200 for transmitting in the uplink to base stations 101-103 and may implement a receive path corresponding to the architecture of receiver 250 for receiving in the downlink from base stations 101-103.

According to the principles of the present disclosure, each one of base stations 101-103 is capable of dynamically allocating uplink channel resources to subscriber stations 111-116 according to the number of subscriber stations that will be receiving downlink data transmissions and will, therefore, be required to send ACK or NACK messages back to a transmitting base station. The uplink channel resources may be independently and selectively allocated for each transmission, rather than being permanently dedicated to particular subscriber stations.

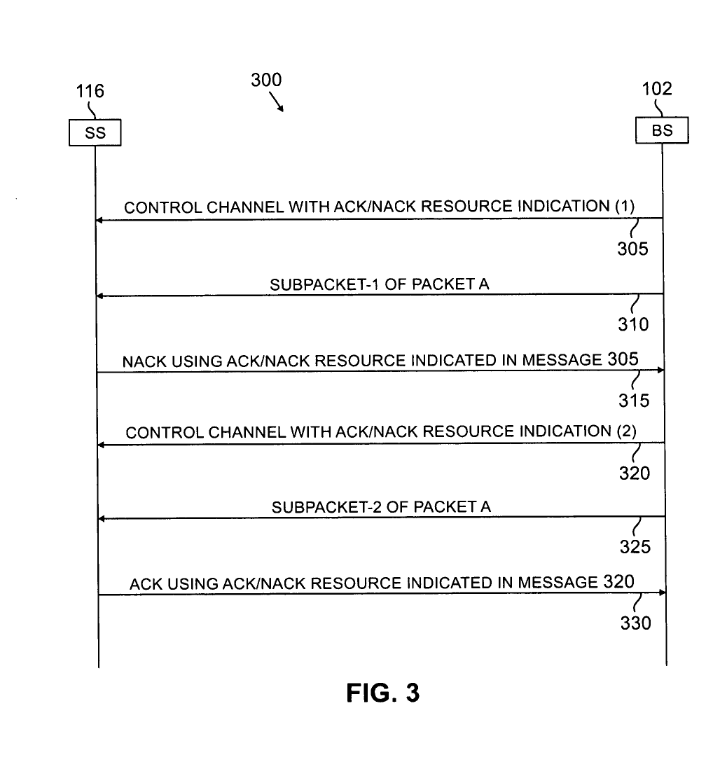

FIG. 3 depicts message flow diagram 300, which illustrates the allocation of uplink channel resources according to the principles of the present disclosure. Base station (BS) 102 transmits control channel message 305 to subscriber station (SS) 116 at the same time that BS 102 transmits data message 310. Control channel message 305 contains ACK/NACK Resource Indication (1), which indicates or identifies the uplink channel resource that SS 116 is to use to transmit an ACK message or a NACK message. Data message 310 contains Subpacket 1 of Packet A. Assuming Subpacket 1 of Packet A is not properly decoded, SS 116 responds by transmitting NACK message 315 using the uplink channel resource indicated in message 305 for sending ACK messages and NACK messages.

BS 102 then transmits control channel message 320 to SS 116 at the same time that BS 102 transmits data message 325. Control channel message 320 contains ACK/NACK Resource Indication (2), which indicates or identifies the uplink channel resource that SS 116 is to use to transmit an ACK message or a NACK message. ACK/NACK Resource Indication (2) in message 320 may be the same as ACK/NACK Resource Indication (1) in message 305, or it may be different. If wireless network 100 implements a hybrid ARQ protocol, data message 325 contains Subpacket 2 of Packet A. SS 116 will combine Subpacket 1 and Subpacket 2 in order to attempt to decode Packet A. Assuming SS 116 is able to decode Packet A from Subpacket 1 and Subpacket 2, SS 116 responds by transmitting ACK message 330 using the uplink channel resource indicated in message 320 for sending ACK messages and NACK messages.

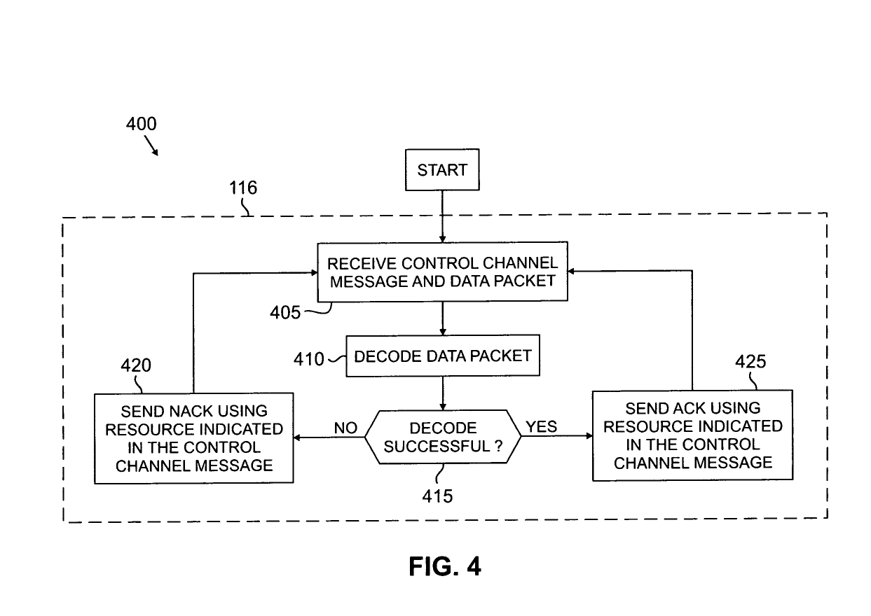

FIG. 4 depicts logic flow diagram 400, which illustrates the allocation of uplink channel resources in subscriber station (SS) 116 according to the principles of the present disclosure. SS 116 receives an incoming data packet (or subpacket) and a control channel message from BS 102 (process step 405). The control channel message identifies the uplink channel to be used by SS 116 to send an ARQ feedback message to BS 102. SS 116 then decodes the data packet or subpacket (process step 410).

Next, SS 116 verifies the decoded data to determine if the decode was successful, according to the forward error correcting (FEC) scheme or cyclic redundancy check (CRC) scheme that may be used (process step 415). If the decode was unsuccessful, SS 116 sends a NACK message using the uplink channel resource indicated in the control message (process step 420). SS 116 then receives the next data packet and associated control channel message (process step 405). If the decode was successful, SS 116 sends an ACK message using the uplink channel resource indicated in the control message (process step 425). SS 116 then receives the next data packet and associated control channel message (process step 405).

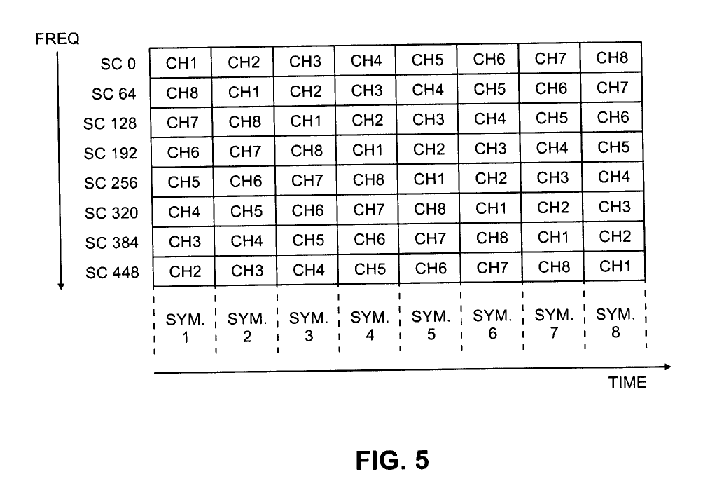

FIG. 5 illustrates an exemplary time-frequency grid for transmitting in logical uplink channels in wireless network 100 according to one embodiment of the present disclosure. In the example in FIG. 5, it is assumed that OFDM symbols are transmitted in transmission time interval (TTI). The TTI has a length of 0.5 milliseconds and each OFDM symbol comprises 512 subcarriers. In order to provide frequency-diversity, every 64^{th} subcarrier is used for a given logical channel. The logical channels are defined by a specific mapping to the time-frequency grid in FIG. 5. For example, logical channel CH1 uses subcarriers SC 0, SC 64, SC 128, SC 256, SC 320, SC 384, and SC 448 in OFDM symbols 1, 2, 3, 4, 5, 6, 7 and 8 respectively. Similarly, logical channel CH2 uses subcarriers SC 0, SC 64, SC 128, SC 256, SC 320, SC 384, and SC 448 in OFDM symbols 2, 3, 4, 5, 6, 7, 8, and 1, respectively. In this mapping scheme, each logical channel benefits from both frequency-diversity and time-diversity.

The hybrid ARQ feedback information from a given subscriber station may be mapped to one or more of these channels in a number of ways. For example, if a single ACK/NACK bit is used, where a Logic 1 indicates a success and a Logic 0 indicates a failure, the transmitted bit can be repeated in order to match the number of symbols available in the logical channel. For example, if eight symbols are used in a logical channel (as in FIG. 5), the ACK/NACK bit is repeated eight times, once in each symbol. It is also possible to spread the ACK/NACK bit over multiple time-frequency grids using, for example a Walsh code. In the case of an ARQ feedback message comprising more than one bit to indicate failure or success of multiple simultaneously received packets or subpackets, the sequence of feedback bits may be coded before mapping to a logical channel.

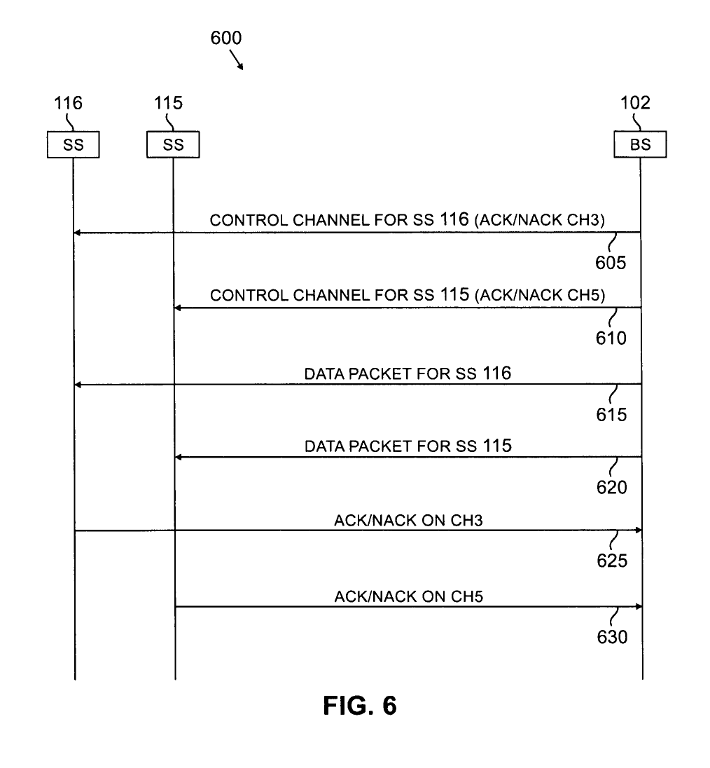

FIG. 6 depicts message flow diagram 600, which illustrates ACK/NACK feedback from multiple subscriber stations according to the principles of the present disclosure. Base station (BS) 102 initially transmits control channel message 605 to subscriber station (SS) 116 and control channel message 610 to subscriber station (SS) 115. Control channel message 605 indicates that SS 116 should use logical uplink channel CH3 to send an ACK message or a NACK message back to BS 102. Control channel message 610 indicates that SS 115 should use logical uplink channel CH5 to send an ACK message or a NACK message back to BS 102.

BS 102 also transmits data message 615 containing a first data packet or a first data subpacket to SS 116 and transmits data message 621 containing a second data packet or a second data subpacket to SS 115. SS 116 decodes the first data packet or subpacket and SS 115 decodes the second data packet or subpacket. Depending on the results of the decoding operations, SS 116 then transmits an ACK message or a NACK message to BS 102 on uplink channel CH3 and SS 115 transmits an ACK message or a NACK message to BS 102 on uplink channel CH5.

By indicating the identity of the ACK/NACK channel in the control channel for the subscriber station, the maximum number of ACK/NACK channels only needs to be equal to the maximum number of subscriber stations scheduled simultaneously for transmission. Thus, a wireless network according to the principles of the present disclosure conserves channel resources and makes more bandwidth available for transmitting data.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in an orthogonal frequency division multiplexing (OFDM) wireless network capable of communicating with a plurality of subscriber stations in a coverage area of the OFDM wireless network, a base station capable of transmitting to a first subscriber station a first control message indicating to the first subscriber station a first uplink channel to be used by the first subscriber station for transmitting a first ACK/NACK message back to the base station.

2. The base station as set forth in claim 1, wherein the base station is further capable of transmitting to the first subscriber station a first data traffic message associated with the first control message, wherein the first ACK/NACK message transmitted back to the base station indicates whether the first data traffic message was correctly received.

3. The base station as set forth in claim 2, wherein the base station is further capable of transmitting to the first subscriber station a subsequent control message indicating to the first subscriber station a second uplink channel to be used by the first subscriber station for transmitting a second ACK/NACK message back to the base station.

4. The base station as set forth in claim 3, wherein the second uplink channel is different that the first uplink channel.

5. The base station as set forth in claim 2, wherein the base station is further capable of transmitting to a second subscriber station a second control message indicating to the second subscriber station a second uplink channel to be used by the second subscriber station for transmitting a second ACK/NACK message back to the base station.

6. The base station as set forth in claim 5, wherein the base station is further capable of transmitting to the second subscriber station a second data traffic message associated with the second control message, wherein the second ACK/NACK message transmitted back to the base station indicates whether the second data traffic message was correctly received.

7. The base station as set forth in claim 6, wherein the base station is further capable of transmitting to the second subscriber station a subsequent control message indicating to the second subscriber station a third uplink channel to be used by the second subscriber station for transmitting a third ACK/NACK message back to the base station.

8. The base station as set forth in claim 7, wherein the third uplink channel is different that the second uplink channel.

9. An orthogonal frequency division multiplexing (OFDM) wireless network comprising a plurality of base stations capable of communicating with a plurality of subscriber stations in a coverage area of the OFDM network, wherein each of the plurality of base stations is capable of transmitting to a first subscriber station a first control message indicating to the first subscriber station a first uplink channel to be used by the first subscriber station for transmitting a first ACK/NACK message back to the each base station.

10. The OFDM wireless network as set forth in claim 9, wherein the each base station is further capable of transmitting to the first subscriber station a first data traffic message associated with the first control message, wherein the first ACK/NACK message transmitted back to the each base station indicates whether the first data traffic message was correctly received.

11. The OFDM wireless network as set forth in claim 10, wherein the each base station is further capable of transmitting to the first subscriber station a subsequent control message indicating to the first subscriber station a second uplink channel to be used by the first subscriber station for transmitting a second ACK/NACK message back to the each base station.

12. The OFDM wireless network as set forth in claim 11, wherein the second uplink channel is different that the first uplink channel.

13. The OFDM wireless network as set forth in claim 10, wherein the each base station is further capable of transmitting to a second subscriber station a second control message indicating to the second subscriber station a second uplink channel to be used by the second subscriber station for transmitting a second ACK/NACK message back to the each base station.

14. The OFDM wireless network as set forth in claim 13, wherein the each base station is further capable of transmitting to the second subscriber station a second data traffic message associated with the second control message, wherein the second ACK/NACK message transmitted back to the each base station indicates whether the second data traffic message was correctly received.

15. The OFDM wireless network as set forth in claim 14, wherein the each base station is further capable of transmitting to the second subscriber station a subsequent control message indicating to the second subscriber station a third uplink channel to be used by the second subscriber station for transmitting a third ACK/NACK message back to the each base station.

16. The OFDM wireless network as set forth in claim 15, wherein the third uplink channel is different that the second uplink channel.

17. For use in an orthogonal frequency division multiplexing (OFDM) network capable of communicating with a plurality of subscriber stations in a coverage area of the OFDM network, a method of allocating uplink channel resources to selected ones of the subscriber stations, the method comprising the steps of
transmitting to a first subscriber station a first data traffic message;
transmitting to the first subscriber station a first control message associated with the first data traffic message, wherein the first control message indicates to the first subscriber station a first uplink channel to be used by the first subscriber station for transmitting a first ACK/NACK message back to the base station;
transmitting to a second subscriber station a second data traffic message; and
transmitting to the second subscriber station a second control message associated with the second data traffic message, wherein the second control message indicates to the second subscriber station a second uplink channel to be used by the second subscriber station for transmitting a second ACK/NACK message back to the base station.

18. The method as set forth in claim 17, wherein the first ACK/NACK message transmitted back to the base station indicates whether the first data traffic message was correctly received.

19. The method as set forth in claim 17, wherein the second ACK/NACK message transmitted back to the base station indicates whether the second data traffic message was correctly received.

20. The method as set forth in claim 17, further comprising the steps of:
transmitting to the first subscriber station a third data traffic message; and
transmitting to the first subscriber station a third control message associated with the third data traffic message, wherein the third control message indicates to the first subscriber station a third uplink channel to be used by the first subscriber station for transmitting a third ACK/NACK message back to the base station.

21. The method as set forth in claim 20, wherein the third uplink channel is different that the first uplink channel.

22. The method as set forth in claim 20, further comprising the steps of:
transmitting to the second subscriber station a fourth data traffic message; and
transmitting to the second subscriber station a fourth control message associated with the fourth data traffic message, wherein the fourth control message indicates to the second subscriber station a fourth uplink channel to be used by the second subscriber station for transmitting a fourth ACK/NACK message back to the base station.

23. The method as set forth in claim 22, wherein the fourth uplink channel is different that the second uplink channel.

24. A subscriber station for use in an orthogonal frequency division multiplexing (OFDM) wireless network capable of communicating with a plurality of subscriber stations in a coverage area of the OFDM network, wherein the subscriber station is capable of receiving from a first base station of the OFDM wireless network a first data traffic message and a first control message associated with the first data traffic message, and wherein the subscriber station is further capable of determining from the first control message a first uplink channel to be used by the first subscriber station for transmitting a first ACK/NACK message back to the base station.

25. The subscriber station as set forth in claim 24, wherein the first ACK/NACK message transmitted back to the base station indicates whether the first data traffic message was correctly received by the subscriber station.

26. The subscriber station as set forth in claim 25, wherein the subscriber station is further capable of receiving from the first base station a second data traffic message and a second control message associated with the second data traffic message, and the subscriber station is further capable of determining from the second control message a second uplink channel to be used by the first subscriber station for transmitting a second ACK/NACK message back to the base station.

27. The subscriber station as set forth in claim 26, wherein the second ACK/NACK message transmitted back to the base station indicates whether the second data traffic message was correctly received by the subscriber station.
